(19) United States
(12) Patent Application Publication
(10) Pub. No.: US 2023/0059655 A1
(43) Pub. Date: Feb. 23, 2023

(54) CONTROLLABLE GAS-STORAGE-FORM GAS SUPPLY TUBE DEVICE

(71) Applicant: Tien-I Bao, New Taipei City (TW)

(72) Inventor: Tien-I Bao, New Taipei City (TW)

(21) Appl. No.: 17/406,104

(22) Filed: Aug. 19, 2021

(51) Int. Cl. F17C 13/04; F16K 11/07; F16K 24/04; F17C 9/00

(52) U.S. Cl. CPC F17C 13/04; F16K 11/0716; F16K 24/04; F17C 9/00; F17C 2205/0326; F17C 2205/0352; F17C 2221/013

(57) ABSTRACT

A controllable gas-storage-form gas supply tube device includes a three way tube having a first opening, a second opening and a third opening; an electric control valve device installed in the three way tube for controlling connections of the three openings; an input tube, a close form air storage tube and a draining tube are connected to the first, second and third openings, respectively. When the electric control valve device is at a first position, the third opening is closed and the first and second openings are communicated so that gas from the input tube flows to the close form air storage tube and is stored therein. When the electric control valve device is at a second position, the first opening is closed, and the second and third openings are communicated so that gas in the close form air storage tube flow to the draining tube.

### FIELD OF THE INVENTION

The present invention is related to three way valves, and in particular to a controllable gas-storage-form gas supply tube device.

### BACKGROUND OF THE INVENTION

A prior two way tube includes an input tube and an output tube. When it is desire to control the flow of the output tube, it is often that a speed adjustment valve is installed to the output tube. However, control of the speed adjustment valve is unstable and thus the flow is also unstable, even the flow of everyday is not identical. For a control system needing fix flow volume, this way for control of flow is not practical.

If it is desire to have stable output flow in the output tube, it is necessary to install a speed adjustment valve, a pressure sensor, a temperature sensor and a flow controller to the output tube. Then the measured temperature and pressure are feedback to the flow controller for compensation of flow. Then the compensation value is used to adjust the opening of the speed adjustment valve.

However, the method needs higher cost and this the system cost is also increased. It may be acceptable for a high cost system, such as an electronic system, but for low cost system (such as biological farming), it is a big burden to users. Although the adjustment can be achieved manually, this is time and labor wasted and unstableness is also generated since the manual operation is not regular.

Therefore, the present invention desires to provide a new system which can improve the defect above mentioned.

### SUMMARY OF THE INVENTION

Accordingly, the object of the present invention is to provide a controllable gas-storage-form gas supply tube device, wherein the close form air storage tube is used to store input gas and the control circuit is used to control the switch period of the close form air storage tube so that flow volume from the close form air storage tube to the draining tube is controllable. The structure of the present invention is simple. A speed adjustment valve may be installed on the draining tube for controlling the flow to be uniformly along the draining tube. However, in the prior art, pressure sensors, temperature sensors and flow meters are needed to be installed, these devices will increase the overall cost. Therefore, the present invention provides a lower cost and still can provide steady flow to the draining tube.

To achieve above object, the present invention provides a controllable gas-storage-form gas supply tube device, comprising: a three way tube having a first opening, a second opening and a third opening; an electric control valve device installed in the three way tube; the electric control valve device serving to control connections of the first opening, the second opening and the third opening of the three way tube; an input tube having one end connected to the first opening of the three way tube for inputting gas to the three way tube from the first opening; a close form air storage tube having one end connected to the second opening of the three way tube, and another end of the close form air storage tube being closed; the close form air storage tube serving to receive gas from the input tube and store the gas; a draining tube having one end connected to the third opening of the three way tube for receiving gas from the close form air storage tube; and wherein when the electric control valve device is at a first position, the third opening is closed and the first opening is communicated to (connected to) the second opening so that gas from the input tube flows to three way tube and then to the close form air storage tube and is stored in the close form air storage tube; when the electric control valve device is at a second position, the first opening is closed, and the second opening is communicated to (connected to) the third opening so that gas flows into the three way tube from the close form air storage tube and then flow to the draining tube and then drain out from the draining tube.

### BRIEF DESCRIPTION OF THE DRAWINGS

FIG. 1 is an assembly schematic view of the elements of the present invention, wherein it is shown that the electric control valve device is installed at a first position.

FIG. 2 is an assembly schematic view of the elements of the present invention, wherein it is shown that the electric control valve device is installed at a second position.

FIG. 3 is a schematic view showing that a speed adjustment valve is added to the draining tube according to the present invention.

FIG. 4 is a schematic view along the line A-A′ of FIG. 1.

FIG. 5 is schematic view showing the assembly of the elements of the present invention.

FIG. 6 is a structural block diagram showing the electric control valve device and the control circuit of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

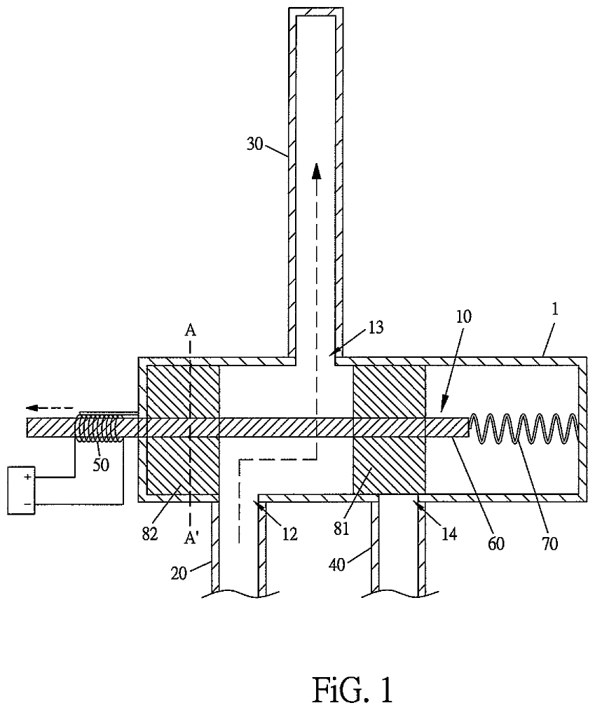

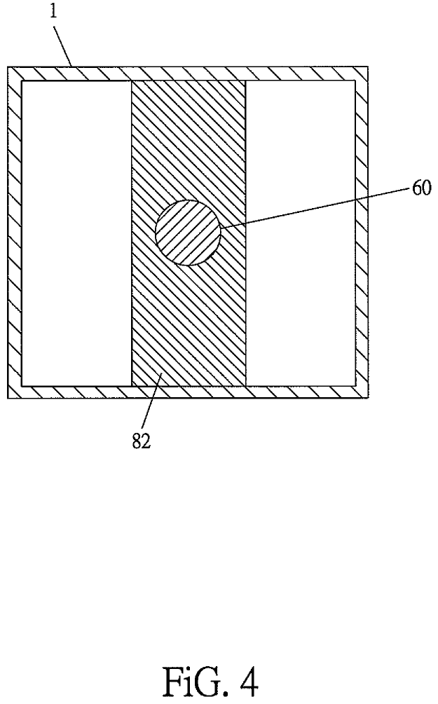

With reference to FIGS. 1 to 6, the structure of the present invention is illustrated. The present invention includes following elements.

A three way tube 1 includes a first opening 12, a second opening 13 and a third opening 14.

An electric control valve device 10 is installed on the three way tube 1 for controlling connections of the first opening 12, the second opening 13 and the third opening 14 of the three way tube 1.

An input tube 20 has one end connected to the first opening 12 of the three way tube 1 for inputting gas to the three way tube 1 from the first opening 12.

A close form air storage tube 30 has one end connected to the second opening 13 of the three way tube 1 and another end of the close form air storage tube 30 is closed. The close form air storage tube 30 serves for receiving gas from the input tube 20 and storing the gas therein.

A draining tube 40 has one end connected to the third opening 14 of the three way tube 1 for receiving gas from the close form air storage tube 30 and draining the gas out.

When the electric control valve device 10 is at a first position, the third opening 14 is closed and the first opening 12 is communicated to (connected to) the second opening 13 so that gas from the input tube 20 can flow to three way tube 1 and then to the close form air storage tube 30 and is stored in the close form air storage tube 30. When the electric control valve device 10 is at a second position, the first opening 12 is closed, and the second opening 13 is communicated to (connected to) the third opening 14 so that gas flows into the three way tube 1 from the close form air storage tube 30 and then flow to the draining tube 40 and then drain out from the draining tube.

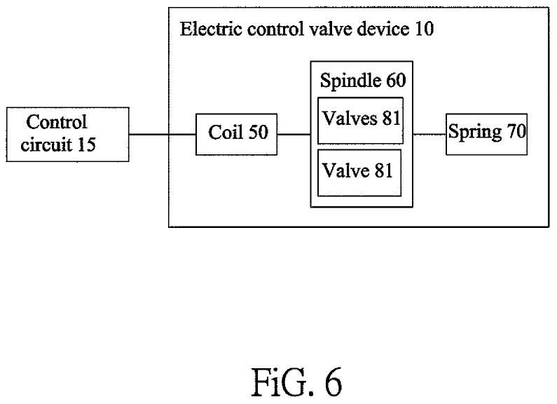

A control circuit 15 is connected to the electric control valve device 10 (referring to FIG. 6) for controlling the electric control valve device 10 to switch between the first position and the second position. The switching frequency and timing of the electric control valve device 10 between the first position and the second position is adjusted by the control circuit 15.

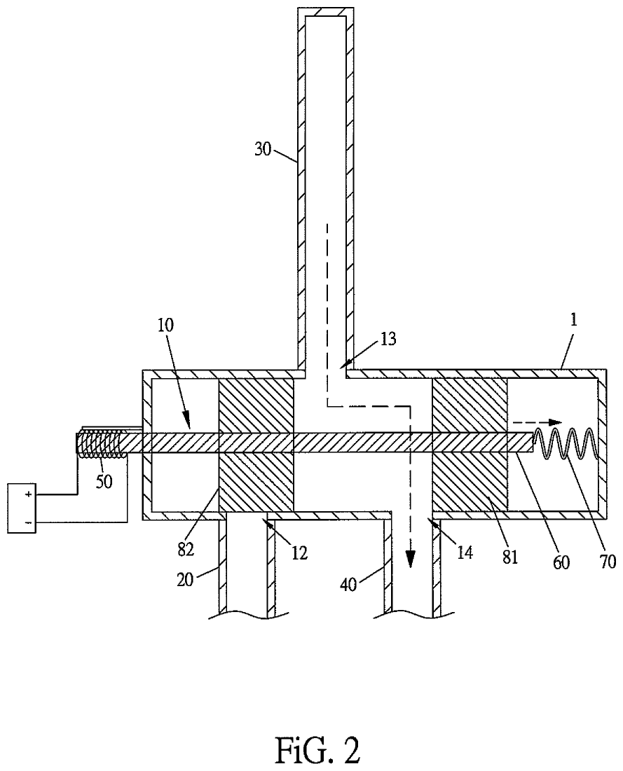

With reference to FIG. 2, a speed adjustment valve 42 is installed on the draining tube 40 for controlling the flow speed of the gas passing through the draining tube 40. Thereby, when gas flows to the draining tube 40 from the close form air storage tube 30, the flow speed is controllable by the speed adjustment valve 42 so as to avoid transient turbulent flow occurred and thus, the flow flowing through the draining tube 40 is uniform.

Operation of the present invention will be described herein. Firstly, the electric control valve device 10 is adjusted to the first position, so that gas flows to the close form air storage tube 30 from the input tube 20 and is stores in the close form air storage tube 30. Then the electric control valve device 10 is adjusted to the second position so that the gas flows to the draining tube 40 from the close form air storage tube 30. Therefore, a switching period is formed. By controlling the switching period of the electric control valve device 10, the volume of flow in the draining tube 40 is controllable. For example, if the volume of gas stored in the close form air storage tube 30 is 400 CC and the switching period is 3 per second, it is known that 1200 cc gas enters into the draining tube 40 per second. Furthermore, the storage volume of the close form air storage tube 30 is controllable (for example to change the size of the close form air storage tube 30) and the switching period of the close form air storage tube 30 is changeable so that the gas volume entering into the draining tube 40 is changeable.

An example about the electric control valve device 10 is described in the following so as to further understand the operation of the present invention. With reference to FIGS. 1, 2 and 4, the electric control valve device 10 further includes the following elements.

A coil 50 is fixed within the three way tube 1. When the coil 50 is conducted, the coil 50 is energized so that center portion of the coil 50 has magnetic field.

A spindle 60 is positioned within the three way tube 1. One end of the spindle 60 is installed within the coil 50 and another end thereof is connected to a spring 70. One end of the spring 70 is fixed on the three way tube 1 and is at an opposite position with respect to the position fixing the coil 50. When the coil 50 is conducted and generates magnetic field, the spindle 60 is attracted and pulls the spring 70 to move toward the coil 50. When the coil 50 is not conducted, the spindle 60 is pulled by the spring 70 and moves toward the spring 70.

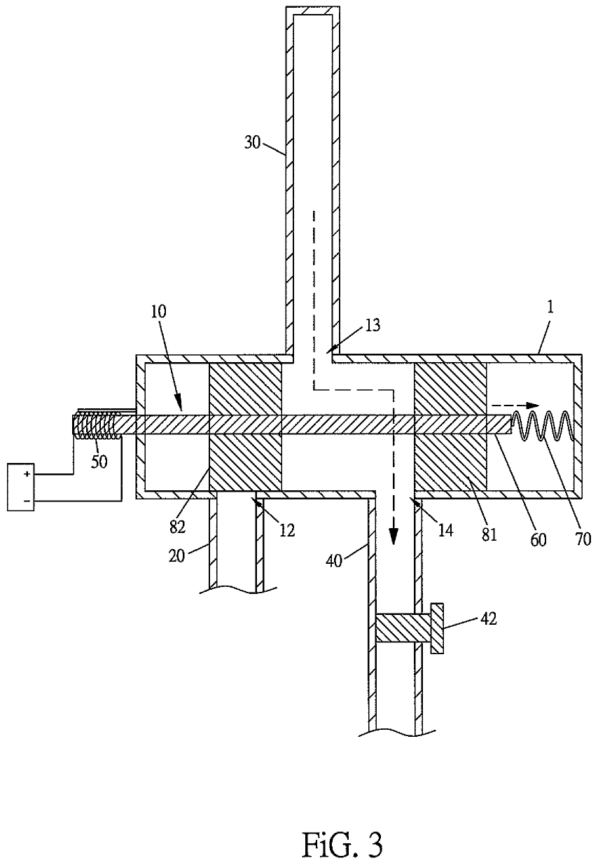

Two valves 81, 82 (referring to FIG. 3) are installed on the spindle 60. Movement of the spindle 60 will control positions of the two valves 80, 81 so that when the electric control valve device 10 is positioned at the first position, one valve 81 will seal the third opening 14, and the first opening 12 is communicated to (connected to) the second opening 13. When the electric control valve device 10 is at the second position, another valve 82 will seal the first opening 12, the second opening 13 is communicated to (connected to) the third opening 14.

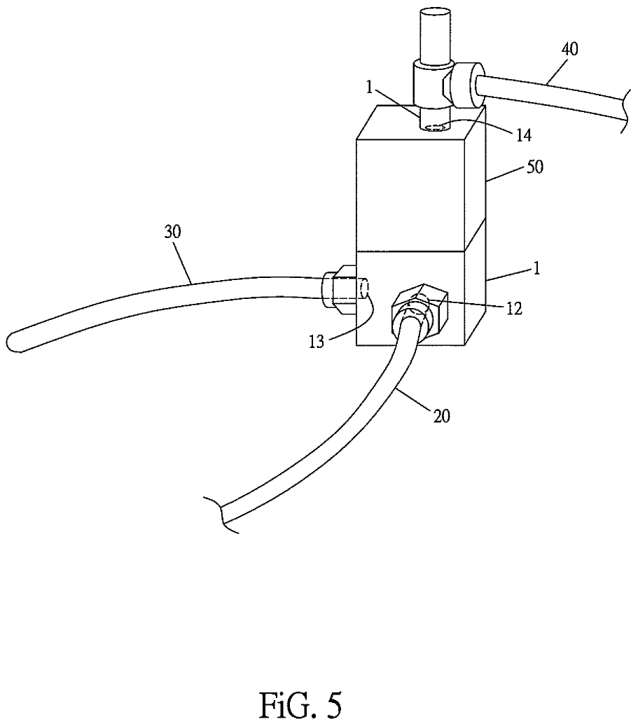

To control the coil 50 to conduce or not to conduct, the switch period of the electric control valve device 10 is controllable. Referring to FIGS. 1 and 3, one example is illustrated. Herein, if the electric control valve device 10 is at the first position, the coil 50 is energized, and if the electric control valve device 10 is at the second position, the coil 50 is not energized. However the present invention is not confined to this design, the first position may be a de-energized position and the second position may be an energized position. FIG. 5 is an assembly view of the elements of the present invention, however, the connections of the first opening 12, second opening 13 and the third opening 14 to the input tube 20, the close form air storage tube 30, and the draining tube 40 are changeable as desired.

While the conduction and non-conduction of the coil 50 are used to control the connections between the input tube 20, the close form air storage tube 30 and the draining tube 40 so as to achieve the object of control the flow of the gas. Therefore, the present invention is not confined to the connection ways shown in the drawings.

Advantages of the present invention will be described herein. In the present invention, the close form air storage tube is used to store input gas and the control circuit is used to control the switch period of the close form air storage tube so that flow volume from the close form air storage tube to the draining tube is controllable. The structure of the present invention is simple. A speed adjustment valve may be installed on the draining tube for controlling the flow to be uniformly along the draining tube. However, in the prior art, pressure sensors, temperature sensors and flow meters are needed to be installed, these devices will increase the overall cost. Therefore, the present invention provides a lower cost and still can provide steady flow to the draining tube.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A controllable gas-storage-form gas supply tube device, comprising:
a three way tube having a first opening, a second opening and a third opening;
an electric control valve device installed in the three way tube for controlling connections of the first opening, the second opening and the third opening of the three way tube;
an input tube having one end connected to the first opening of the three way tube for inputting gas to the three way tube from the first opening;
a close form air storage tube having one end connected to the second opening of the three way tube, and another end of the close form air storage tube being closed; the close form air storage tube serving to receive gas from the input tube and store the gas;
a draining tube having one end connected to the third opening of the three way tube for receiving gas from the close form air storage tube; and
wherein when the electric control valve device is at a first position, the third opening is closed and the first opening is communicated to the second opening so that gas from the input tube flows to three way tube and then to the close form air storage tube and is stored in the close form air storage tube; when the electric control valve device is at a second position, the first opening is closed, and the second opening is communicated to the third opening so that gas flows into the three way tube from the close form air storage tube and then flow to the draining tube and then drain out from the draining tube.

2. The controllable gas-storage-form gas supply tube device as claimed in claim 1, wherein a control circuit is connected to the electric control valve device for controlling the electric control valve device to be switched between the first position and the second position;
wherein the control circuit controls a frequency of the switching of the electric control valve device between the first position and the second position; and
wherein a speed adjustment valve is installed on the draining tube for controlling the flow speed of the gas passing through the draining tube; and thereby, when gas flows to the draining tube from the close form air storage tube, the flow speed is controllable by the speed adjustment valve so as to avoid transient turbulent flow occurred and thus, the flow flowing through the draining tube is steady.

3. (canceled)

4. The controllable gas-storage-form gas supply tube device as claimed in claim 1, wherein the control circuit controls a timing of the switching of the electric control valve device between the first position and the second position.

5. (canceled)

6. The controllable gas-storage-form gas supply tube device as claimed in claim 1, wherein when the electric control valve device is adjusted to the first position, gas flows from the input tube to the close form air storage tube and is stored in the close form air storage tube; when the electric control valve device is adjusted to the second position, the gas flows to the draining tube from the close form air storage tube; therefore, the volume of flow in the draining tube is controllable.

7. The controllable gas-storage-form gas supply tube device as claimed in claim 1, wherein a storage volume of the close form air storage tube is changeable so that the gas volume entering into the draining tube is changeable.

8. The controllable gas-storage-form gas supply tube device as claimed in claim 1, wherein the electric control valve device further including:
a coil fixed within the three way tube; wherein when the coil is conducted, the coil is energized so a center portion of the coil has magnetic field;
a spindle positioned within the three way tube; one end of the spindle being installed within the coil and another end thereof being connected to a spring; one end of the spring being fixed on the three way tube and being at an opposite position with respect to the position fixing the coil; when the coil is conducted and generates magnetic field, the spindle is attracted and pulls the spring to move toward the coil; when the coil is not conducted, the spindle is pulled by the spring and moves toward the spring; and
two valves being installed on the spindle; movement of the spindle controls positions of the two valves so that when the electric control valve device is positioned at the first position, one valve will seal the third opening, and the first opening is communicated to (connected to) the second opening; when the electric control valve device is at the second position, another valve will seal the first opening, the second opening is communicated to (connected to) the third opening.

9. The controllable gas-storage-form gas supply tube device as claimed in claim 1, wherein control of conduction and non-conduction of the coil controls the switching period of the electric control valve device.

10. The controllable gas-storage-form gas supply tube device as claimed in claim 1, wherein the first position is a position in which the coil conducts and the second position is a position in which the coil does not conduct.

11. The controllable gas-storage-form gas supply tube device as claimed in claim 1, wherein the first position is a position in which the coil does not conduct and the second position is a position in which the coil conducts.

12. The controllable gas-storage-form gas supply tube device as claimed in claim 1, wherein input gas from the input tube is CO2.
